(19) United States
(12) Patent Application Publication
(10) Pub. No.: US 2011/0194216 A1
(43) Pub. Date: Aug. 11, 2011

(54) Protection Circuit for Protecting an Intermediate Circuit of a Solar Inverter Against Overvoltages

(75) Inventors: Uwe Schaub, Erlangen (DE); Wolfgang Schmitt, Besigheim (DE); Jens Weidauer, Hochstadt (DE)

(73) Assignee: Siemens Aktiengesellschaft, Munchen (DE)

(21) Appl. No.: 13/122,906

(22) PCT Filed: Sep. 8, 2009
(86) PCT No.: PCT/EP2009/061614

§ 371 Date: Apr. 6, 2011

(30) Foreign Application Priority Data
Oct. 6, 2008 (DE) 10 2008 050 543.9

(51) Int. Cl. H02H 9/04

(52) U.S. Cl. 361/18

(57) ABSTRACT

An input-side protective circuit for protecting an intermediate circuit of an inverter against overvoltages, wherein the input-side protective circuit includes an upstream element for limiting the voltage of the intermediate circuit connected upstream of the intermediate circuit and which is bridgeable by a mechanical switching device that is controllable such that it opens in a feed-in operation of the inverter when an intermediate circuit voltage is greater than a specified voltage limit. The protective circuit also includes an electronic voltage limiter connected downstream of the upstream element and connected in parallel to the intermediate circuit.

### CROSS-REFERENCE TO RELATED APPLICATIONS

This is a U.S. national stage of International Application No. PCT/EP2009/061614, filed on 8 Sep. 2009. This patent application claims the priority of German patent application DE 10 2008 050 543.9 filed 6 Oct. 2008, the content of which application is incorporated herein by reference.

### BACKGROUND OF THE INVENTION

1. Field of the Invention

The invention relates to an input-side protection circuit for protecting an intermediate circuit of an inverter against overvoltages, with the protection circuit having an input element, which is connected upstream of the intermediate circuit and is bridgeable by a controllable mechanical switching device, for voltage limiting in the intermediate circuit, and with the mechanical switching device being controllable such that it opens in a feed mode for the inverter when an intermediate-circuit voltage is greater than a predetermined voltage limit value.

The invention furthermore relates to an inverter having an input-side intermediate circuit for connection to a regenerative DC voltage source, having an output-side power section for feeding an electrical power supply system, and having a controllable input-side protection circuit such as mentioned above.

2. Description of the Related Art

Regenerative DC voltage sources may be, for example, solar modules or a solar array having a multiplicity of such solar modules. They may also be fuel cells or generators for wind power installations or biogas installations.

By way of example, regenerative DC voltage sources can feed a single-phase 50 Hz/230 V electrical power supply system or a 60 Hz/120 V power supply system of a power supply organization. Preferably, regenerative DC voltage sources feed a three-phase Hz/400 V power supply system. Furthermore, an electric current which is produced, for example, photovoltaically can be supplied to a plurality of inverters, which then convert the supplied DC voltage to a power supply system voltage.

The DC voltage which is produced, for example, by a solar array, is dependent on the instantaneous solar radiation and in particular on the electrical load on the solar array. At zero load, this array voltage or output voltage of the solar array reaches its maximum. This voltage is also referred to as the no-load voltage. When on load, i.e., when feeding the electrical power supply system with the inverter, this voltage falls. The inverter preferably has a control unit that controls electronic semiconductor components in the power section of the inverter such that the power fed to the electrical power supply system is a maximum. For this purpose, the control unit preferably performs a so-called tracking program to continuously “search for” the likewise fluctuating maximum power point (MPP).

As a DC voltage source, a solar module or a solar array has an electrical characteristic that approximates that of a current source when loaded. Consequently, the current that is produced for the same assumed solar radiation is essentially independent of the array voltage or output voltage of the solar module or solar array, with the no-load voltage that is produced on the solar module or on the solar array then decreasing rapidly when comparatively lightly loaded (in this context see FIG. 2). The no-load voltage may, however, exceed the maximum permissible operating voltage of the solar inverter when the solar radiation is strong.

In order to avoid unacceptably high voltages at the input of the intermediate circuit, an input-side protection circuit is known from the Patent Abstract of Japan relating to JP 11312022 A. This comprises a series circuit of two resistors as a voltage divider, and three controllable mechanical switching device. If an array voltage that is present on the input side is less than a predetermined voltage limit value, then the mechanical switching device is controlled such that the array voltage is applied directly to the intermediate circuit. The mechanical switching device may comprise relays or contactors.

If the intermediate-circuit voltage exceeds the predetermined voltage limit value, then the switching device is operated such that the array voltage on the series circuit and the centre tap with a divided-voltage, reduced voltage value is applied to the intermediate circuit.

However, if a fault occurs in the inverter and this now blocks the control pulses for controlling the semiconductor switches in the inverter power section, then the applied array voltage is no longer regulated. As a result of the lack of the power supply system feed and the consequential lack of the load on the regenerative DC voltage source, the array voltage now rises suddenly to the no-load voltage, requiring a typical switching time in the range from 100 to 200 ms for this purpose until, in the end, the mechanical switching device releases the bridged resistor, for voltage limiting. However, if the array voltage rises during this time to unacceptably high voltage values beyond the voltage limit value, then the inverter and in particular its overvoltage-sensitive semiconductor switch will be destroyed within a very short time. This is the case in particular for a feeding solar array when the solar radiation is high.
U.S. Publication No. 2008/094867 Al discloses the use of an electronic voltage limiter in a protection circuit.

### SUMMARY OF THE INVENTION

It is thus an object of the invention to provide an improved protection circuit for an inverter.

A further object of the invention is to provide a suitable inverter having the improved protection circuit.

These and other objects and advantages are achieved in accordance with the invention by a protection circuit having an input element connected upstream of an intermediate circuit of an inverter, where the input element is bridgeable by a mechanical switching device, and an electronic voltage limiter connected downstream from the input element and is connected in parallel with the intermediate circuit, where the voltage limiter is thermally configured to absorb the electrical input power which is dropped across the voltage limiter before the mechanical switching means opens.

This allows the voltage applied to the intermediate circuit to be limited to a “semiconductor-compatible” voltage level, with virtually no delay in comparison to mechanical switching elements alone. The overvoltage-sensitive semiconductor switches in the inverter, such as insulated gate bipolar transistors (IGBTs) or metal oxide semiconductor field-effect transistor (MOSFETs), are effectively protected.

The electronic voltage limiter is thermally configured essentially only to receive the electrical input power that is dropped across the voltage limiter before the mechanical switching device opens. Consequently, the protection circuit is allowed to be configured extremely compact. Here, it should be noted that the electrical power that is dropped across the voltage limiter during the switching time of the mechanical switching device is several orders of magnitude greater than the electrical power that is dissipated in the resistors in the series circuit. Here, the resistors that are provided for voltage limiting are typically thermally configured for the unlimited-time situation.

In accordance with one particularly advantageous embodiment, the electronic voltage limit includes a voltage detection unit for detecting the intermediate-circuit voltage, a comparator for comparing a currently detected voltage measured value with a comparison voltage value that corresponds to the voltage limit value, a controllable electronic switching element that is connected downstream from the comparator, and a series circuit that is connected in parallel with the intermediate circuit and comprises the load-side part of the electronic switching element, and a limiting resistor.

This allows the protection circuit in accordance with the invention to be operated independently of the control of the inverter.

In accordance with a preferred embodiment, the comparator comprises a chopper for regulated clocked control of the electronic switching element. The particular advantage is that only a comparatively small power loss occurs in the switching element, while by far the greatest majority of the electrical power is dropped in the input element for voltage limiting. The latter is preferably a resistor, for example a power resistor. The electronic switching element is normally a transistor.

Furthermore, the chopper may have a pulse width modulator for regulated clocked control of the electronic switching element at a constant switching frequency. The circuitry design of the electronic voltage limiter is therefore particularly simple.

In accordance with a further embodiment, the mechanical switching device is controllable such that it is open when the inverter is in the switched-off state. The input-side voltage limiting is therefore active even when the inverter is switched off.

The object of the invention is also achieved by an inverter having a protection circuit in accordance with the invention. All the components of the protection circuit are preferably integrated on the circuit mount for controlling the inverter.

The inverter in accordance with the invention is preferably a solar inverter for input-side connection to a solar module or to a solar array. Alternatively, the inverter may also be connected to a fuel cell.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and advantageous embodiments of the invention will be described in more detail in the following text with reference to the following figures, in which:

FIG. 1 is graph depicting an inverter having an input-side protection circuit according to the prior art for protection of the intermediate circuit of the inverter against overvoltages,

FIG. 2 is graphical plot depicting a current/voltage characteristic of a solar module as an example of a regenerative DC voltage source,

FIG. 3 is an exemplary schematic block diagram of an inverter having a first embodiment of a protection circuit in accordance with the invention, and

FIG. 4 is an exemplary schematic block diagram of an inverter having a protection circuit in accordance with an alternative embodiment of the invention.

### DETAILED DESCRIPTION OF THE PREFERRED EMBODIMENTS

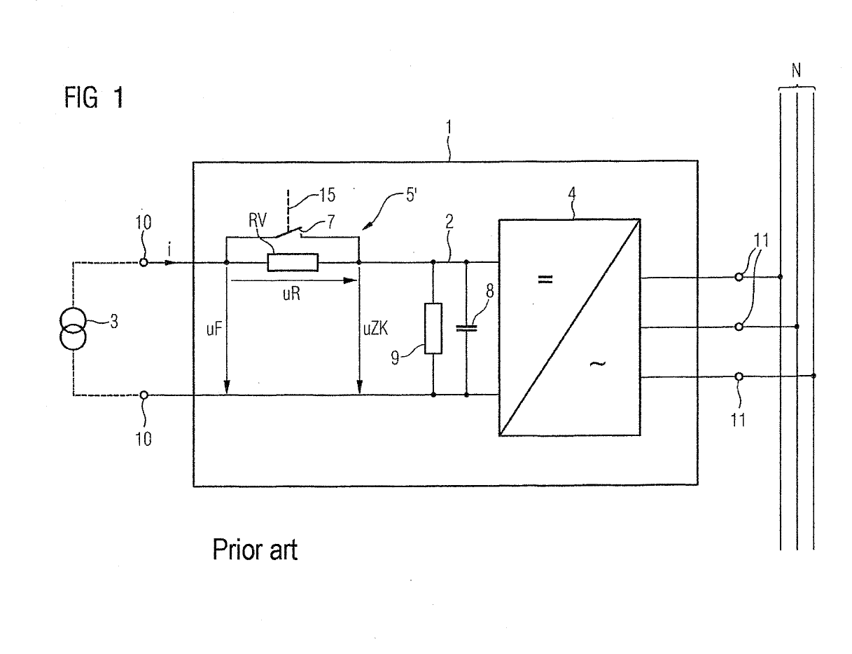

By way of example, FIG. 1 shows an inverter 1 having an input-side protection circuit 5′ in accordance with the prior art for protection of the intermediate circuit 2 of the inverter 1 against overvoltages. In the example shown in FIG. 1, the reference symbol 1 denotes an inverter which is known per se. On the input side the inverter 1 has a voltage intermediate circuit 2, consisting of an intermediate-circuit capacitor 8 and an intermediate-circuit resistor RS as connected in parallel. By way of example, the resistor may be a discrete component. The intermediate-circuit resistor RS may also be a discharge resistor for direct-contact protection. Furthermore, the intermediate circuit 2 is intended for connection to a regenerative DC voltage source 3, such as to a solar array.

A power section 4 for feeding an electrical power supply system N is connected downstream of the output side of the intermediate circuit 2. The power section 4 converts an applied intermediate-circuit DC voltage uZK to an output-side AC voltage. In the example of FIG. 1, the illustrated inverter 1 provides a three-phase power supply system voltage at three output terminals 11.

An input-side protection circuit 5′ for protection against overvoltages is connected upstream of the intermediate circuit 2 and, by way of example, input-side protection circuit 5′ has a controllable mechanical switching device 7 that can bridge a resistor as the input element RV for voltage limiting in the intermediate circuit 2. The mechanical switching device 7 is controlled such that it opens in the feed mode of the inverter 1 when an intermediate-circuit voltage uZK is greater than a predetermined voltage limit value. This mechanical switching device 7 is preferably an electrically controllable relay or contactor. The dashed line 15 symbolizes the controllability of the switching device 7, for example by an electronic control unit in the inverter 1, or by an overvoltage or undervoltage relay.

FIG. 1 shows the inverter 1 in the switched-off state. The mechanical switching device 7, i.e., the make contact of the illustrated relay, is open in this zero-energy state. An array voltage or output voltage of the solar array 3 is annotated uF, i.e., applied to input terminals 10 of the inverter 1. A current that flows, inter alia, through the illustrated input resistor RV is annotated i and produces a voltage drop uR across this input resistor RV. The intermediate-circuit voltage uZK is less than the array voltage uF by this voltage uR. The resistance of the input resistor RV is of such a magnitude that an adequate voltage drop is achieved at a maximum output voltage of the regenerative DC voltage source. Furthermore, the mechanical switching device 7 can be controlled such that, when the inverter 1 is in the feed or the reverse feed mode, the inverter 1 closes when an intermediate-circuit voltage uZK is less than a predeterminable voltage limit value. This is the case when the intermediate-circuit voltage uZK has fallen as a result of the load on the intermediate circuit 2 to such an extent that safe operation of the power section 4 is possible, without any risk of destruction of the semiconductor switches. By way of example, the predeterminable voltage limit value can be fixed at a voltage limit value of 500V, if the maximum output voltage to be expected from the DC voltage source 3, for example, that of a solar array 3, is about 100 V.

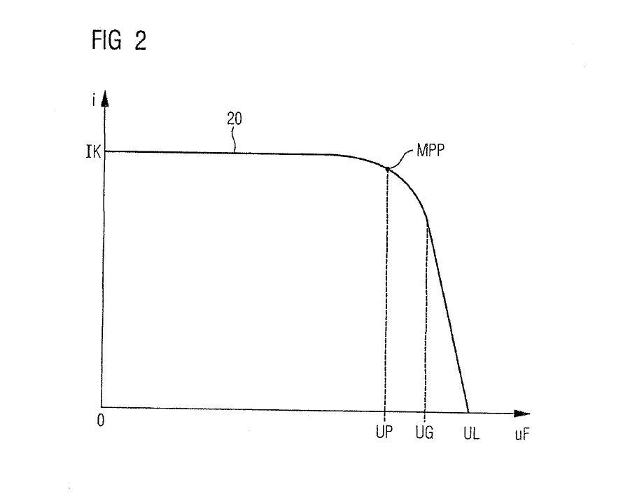

By way of example, FIG. 2 shows a current/voltage characteristic 20 for a solar module as an example of a regenerative DC voltage source. As shown in FIG. 2, the electric current i produced by the solar module is virtually constant over a wide array of voltages uF. Depending on the adjustable load level on the solar module, the power section of the inverter 1 can, in principle, pass through any point on the current/voltage characteristic 20. When the solar module is on no load, the maximum array voltage UL is thus present on the solar module, while a short-circuit current IK occurs when the current module is short-circuited. MPP denotes a maximum power point on the current/voltage characteristic 20 at which maximum feedback into the power supply system is possible. UP denotes the associated array voltage. As FIG. 2 also shows, the array voltage uF decreases relatively quickly when the solar module is loaded. Even a comparatively low load is therefore sufficient to cause the array voltage uF to fall from the maximum no-load voltage UL to a predeterminable example of a limit voltage UG, below which safe operation of the semiconductor switches is possible.

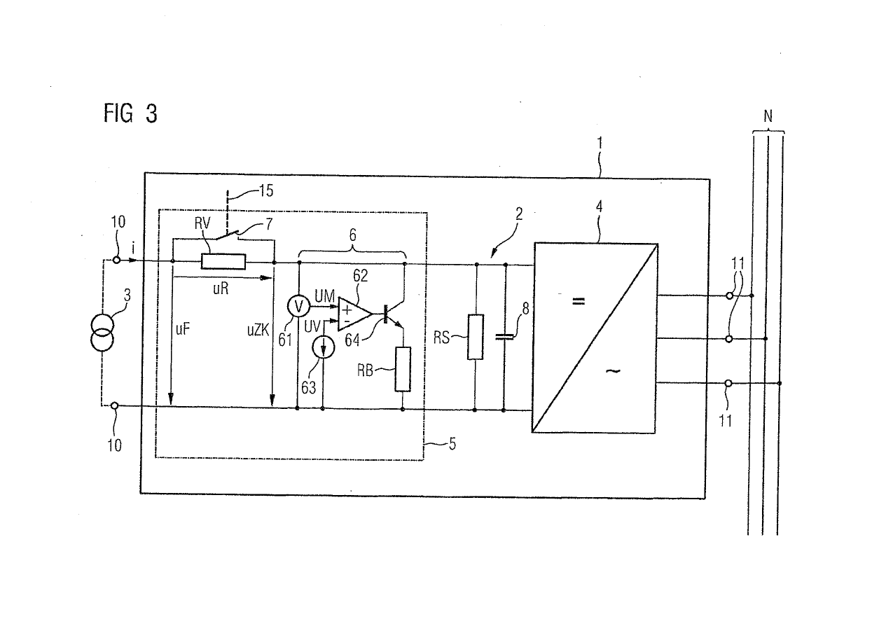

By way of example, FIG. 3 shows an inverter 1 having a first embodiment of a protection circuit 5 in accordance with the invention. As shown in FIG. 3, the protection circuit 5 is preferably already integrated in the inverter 1. In accordance with the presently contemplated embodiment of the invention, the protection circuit 5 has an electronic voltage limiter 6, which is connected downstream from the input element RV comprising a resistor, and is connected in parallel with the intermediate circuit 2. The voltage limiter 6 is preferably thermally configured only to receive the electrical input power that is dropped in the electronic voltage limiter 6 before opening of the mechanical switching device 7, i.e., for a typical time period of about 100 to 200 ms. Depending on the form of the mechanical switching device 7, for example, as an isolating contactor or DC contactor, the time to be bridged thermally may correspond to the switching time for opening the mechanical switching device 7 or else may be less than this, for example, about 50 ms, or more than this, for example, 500 MS.

In the example shown in FIG. 3, the electronic voltage limiter 6 has a voltage detection unit 61 for detection of the intermediate-circuit voltage uZK, and a comparator 62 for comparison of a currently detected voltage measured value UM with a comparison voltage value UV, which corresponds to the voltage limit value UG. Furthermore, the voltage limiter 6 has a controllable electronic switching element 64 which is connected downstream from the comparator 62, and a series circuit, which is connected in parallel with the intermediate circuit 2 and comprises the load-side part of the electronic switching element 64 comprising a transistor, and a limiting resistor RB. The reference symbol 63 denotes a reference voltage source, which provides a voltage that corresponds to the comparison voltage value UV.

If a fault now occurs, for example, in the power section 4 of the inverter 1, then this blocks the control pulses for controlling the semiconductor switches, which are not shown any further. As a result, the intermediate-circuit voltage uZK rises suddenly within a few milliseconds to the no-load voltage UL since, because of the lack of the power supply system 3, it is no longer possible to electrically load the regenerative DC voltage source 3 at the input of the inverter 1. In accordance with the presently contemplated embodiment of the invention, the autonomously operating electrical voltage limiter 6 now, in comparison to a protection circuit of the prior art, limits the voltage rise immediately to the predetermined, maximum permissible voltage limit value UG. After a switching time that is much longer than this has elapsed, the mechanical switching device 7 in the end opens, in order to remove the bridging of the input element or input resistor RV for voltage limiting in the intermediate circuit 2.

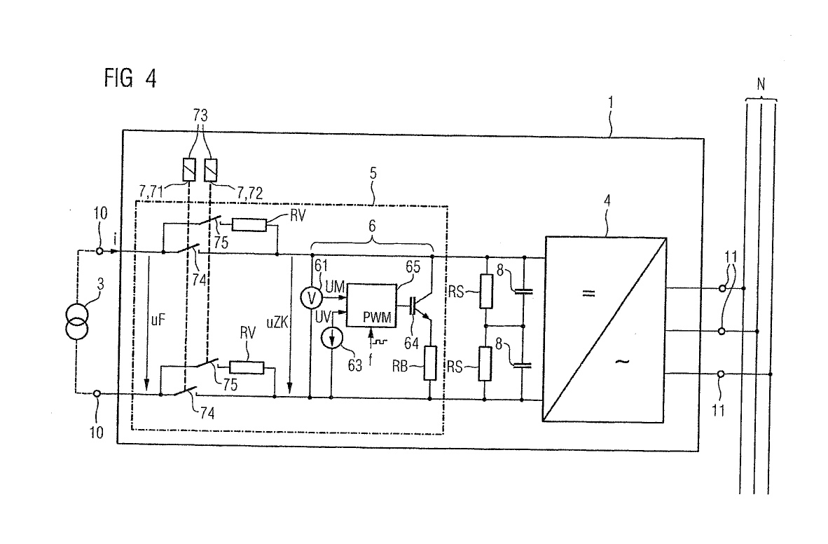

By way of example, FIG. 4 shows a further inverter 1 having an alternative embodiment of the protection circuit 5 in accordance with the invention.

The illustrated inverter 1 differs from the inverter 1 shown in FIG. 3 in that the intermediate circuit 2 has a series circuit of two intermediate-circuit capacitors 8. An intermediate-circuit resistor RS is connected in parallel with each of the intermediate-circuit capacitors 8. A design of an intermediate circuit 2 such as this is frequently used for industrial converters. The two resistors RS typically have the same resistance, for example, a resistance value in the range from 5 to 10 kΩ. The two resistors input resistors RV, which, by way of example, are connected in series on the input side, preferably have approximately the same resistance as the two intermediate-circuit resistors RS.

By way of example, the illustrated protection circuit 5 has a DC contactor 71 and an isolating contactor 72 as controllable, mechanical switching elements 7. Here, each reference symbol 73 denotes a field coil. Furthermore, reference symbols 74, 75 denote a switching contact associated respectively with the DC contactor 71 and the isolating contactor 72. The two contactors 71, 72 are preferably controlled by a control unit, which is not illustrated in any more detail, for the inverter 1.

In the situation in which the inverter 1 is intended to be disconnected from the regenerative voltage source 3, i.e., isolated from the regenerative voltage source, both contactors 72 are controlled to open. In contrast, in the feed mode, the DC contactor 71 is controlled to close, and the isolating contactor 72 is controlled to open. Here, the array voltage uF is applied directly to the intermediate circuit 2. In the situation when the intermediate-circuit voltage uZK exceeds the predetermined, maximum permissible voltage limit value, the DC contactor 71 is controlled to open, and the isolating contactor 72 is controlled to close to provide input-side voltage limiting.

In the present example, the comparator comprises a chopper 65 for regulated clocked control of the electronic switching element 64. The electronic switching element 64 is preferably a switching transistor which is configured for switching operation, for example, an IGBT. Here, the electrical power that has to be absorbed in a short time occurs virtually exclusively in the component that has technically been provided for this purpose, as a limiting resistor RB. Here, this limiting resistor RB has a resistance that is 2 to 4 orders of magnitude less than that of the input resistors RV and the intermediate-circuit resistors RS. In the present example, the limiting resistor would have a resistance in the range of from to 100Ω. However, this also means that the electrical power that is lost is two to four orders of magnitude greater than that in the input resistors RV and the intermediate-circuit resistors RS. However, since this power is present for only a fraction of a second, the limiting resistor RB may have a physical size that is drastically smaller than that of a limiting resistor for long-term absorption of this electrical power.

Furthermore, the chopper 65 has a pulse width modulator PWM for regulated clocked control of the electronic switching element 64 at a constant switching frequency f. The pulse-width-modulated control allows the circuitry of the electronic voltage limiter 6 to be configured particularly simple. The switching frequency f is typically in the region of 10 kHz. This allows a particularly fast control action for limiting the intermediate-circuit voltage uZK applied to the intermediate circuit 2 to semiconductor-compatible voltage values.

Although the invention has been illustrated and described in detail by means of the exemplary embodiments, the invention is not restricted by the disclosed examples, and other variations can be derived therefrom by a person skilled in the art, without departing from the scope of protection of the invention.

Thus, an input-side protection circuit 5 is provided for protection of an intermediate circuit 2 of an inverter 1 against overvoltages. The protection circuit 5 has an input element RV, which is connected upstream of the intermediate circuit 2 and can be bridged by a controllable mechanical switching device 7, for voltage limiting in the intermediate circuit 2. The mechanical switching device 7 is controllable such that, when the inverter 1 is in the feed mode, it opens at an intermediate-circuit voltage uZK greater than a predetermined voltage limit value UG. In accordance with the disclosed embodiments of the invention, the protection circuit has an electronic voltage limiter 6, which is connected downstream from the input element RV and is connected in parallel with the intermediate circuit 2.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-9. (canceled)

10. An input-side protection circuit for an intermediate circuit of an inverter against over voltages, comprising:
an input element connected upstream of the intermediate circuit arranged and dimensioned to limit voltage in the intermediate-circuit;
a controllable mechanical switching device, the input element being bridgeable by the controllable mechanical switching device, the controllable mechanical switching device being controllable to open in a feed mode for the inverter when an intermediate-circuit voltage is greater than a predetermined voltage limit value; and
an electronic voltage limiter connected downstream from the input element and connected in parallel with the intermediate circuit, the electronic voltage limiter being thermally configured to absorb electrical input power dropped across the voltage limiter before the mechanical switching device opens.

11. The protection circuit as claimed in claim 10, wherein the electronic voltage limiter includes a voltage detection unit for detection of the intermediate-circuit voltage, a comparator for comparison of a currently detected intermediate-circuit voltage measured value with a comparison voltage value which corresponds to the voltage limit value, and a controllable electronic switching element connected downstream from the comparator, the controllable switching circuit being connected with a series circuit connected in parallel with the intermediate circuit, and the series circuit comprising a load-side part of the electronic switching element and a limiting resistor.

12. The protection circuit as claimed in claim 11, wherein the comparator comprises a chopper configured to regulate clocked control of the electronic switching element.

13. The protection circuit as claimed in claim 12, wherein the chopper includes a pulse width modulator for the regulated clocked control of the electronic switching element at a constant switching frequency.

14. The protection circuit as claimed in claim 11, wherein the input element is a resistor, and the electronic switching element is a switching transistor.

15. The protection circuit as claimed in claim 10, wherein the mechanical switching device is controllable to open when the inverter is in a switched-off state.

16. An inverter comprising:
an input-side intermediate circuit for connection to a regenerative DC voltage source;
an output-side power section for feeding an electrical power supply system; and
an input-side protection circuit for protecting the input-side intermediate circuit against overvoltages, the input-side protection circuit comprising:
an input element connected upstream of the input-side intermediate circuit for arranged and dimensioned to limit in the input-side intermediate circuit;
a controllable mechanical switching device, the input element being bridgeable by the controllable mechanical switching device, and the mechanical switching device being controllable by the inverter to open in a feed mode of the inverter when an intermediate-circuit voltage is greater than a predetermined voltage limit value; and
an electronic voltage limiter connected downstream from the input element and connected in parallel with the input-side intermediate circuit, the electronic voltage limiter being thermally configured to absorb electrical input power dropped across the voltage limiter before the mechanical switching device opens.

17. The inverter as claimed in claim 16, wherein the inverter is a solar inverter for connection to an input-side of one of a solar module, a solar array and a fuel cell.
